(19) United States
(12) Patent Application Publication
(10) Pub. No.: US 2005/0169112 A1
(43) Pub. Date: Aug. 4, 2005

(54) Portable type electronic device having sounding function

(76) Inventor: Ikue Shimizu, Chiba-shi (JP)

Correspondence Address: BRUCE L. ADAMS, ESQ., 50 BROADWAY-31ST FLOOR, NEW YORK, NY, 10004, US

(21) Appl. No.: 11/043,866

(22) Filed: Jan. 26, 2005

(30) Foreign Application Priority Data
Jan. 29, 2004 (JP) 2004-021671

(51) Int. Cl. G04B 37/00

(52) U.S. Cl. 368/255

(57) ABSTRACT

A portable type electronic device with a sounding function having a piezoelectric element, which fixes a button-type battery in a battery housing recess while making it possible for the user to replace the battery easily and which enables the piezoelectric element to produce a sound in a sufficient volume. A battery cover is mounted on the electronic watch body of a portable type electronic watch having a sounding function. A piezoelectric element is mounted on the bottom face of a battery cover recess formed in the inner side of the battery cover. A Plate-shaped partition member is fixed at its circumferential edge portion to the opening of the battery cover recess while forming a clearance between it self and the piezoelectric element. A button-type battery is housed in a battery housing recess of the electronic watch body and is fixed by the push of the plate-shaped partition member.

### BACKGROUND OF THE INVENTION

1. Field of the Invention

The present invention relates to a portable type electronic device having a sounding function such as an alarming electronic watch to be carried on the wrist of a user and, more particularly, to a portable type electronic watch having an battery cover, to which a sound producing piezoelectric element is attached.

2. Description of the Prior Art

In JP-A-2002-221582 (i.e., Patent Publication 1), there is disclosed a portable type watch having an electronic buzzer, in which a cup-shaped housing cover is removably attached to the back face side of a watch case for housing a movement. The electronic buzzer is housed in an additional housing unit, which is defined by a housing cover and the back face of a watch case. The electronic buzzer is configured of a printed circuit board, on which a sounding unit utilizing a piezoelectric element, a switch and a battery are packaged. With this configuration, therefore, the additional housing unit can retain a sufficient capacity, can house a large battery and has a high workability for the battery replacement or the maintenance. However, this housing cover is a member having a capacity as large as that of the watch case so that it makes it impossible to reduce the size of the portable type watch having the electronic buzzer. Moreover, the battery is packaged in the printed circuit board. This raises a problem that the user cannot replace the battery easily.

A watch case structure for the user to replace the battery easily without enlarging the case size of the portable type watch adopts the battery hatch structure, for example, which is disclosed in JP-A-2003-36829 (i.e., Patent Publication 2). In short, the structure is provided with the battery hatch, which is removably mounted in the back cover of the watch case. This battery hatch has a battery housing recess formed to house a button-type battery. With this structure, therefore, the battery is left housed in the battery housing recess no matter when the battery hatch is mounted in or demounted from the back cover of the watch case.

Therefore, the user can perform the battery replacement easily. In Patent Publication 2, moreover, there is disclosed a battery hatch structure of the prior art, in which the battery housing recess is formed in a movement structure and in which the battery cover for the battery replacement is disposed at such a portion of the watch case as corresponds to the battery housing recess. In the former battery hatch structure, the battery is clamped and fixed between the bottom face of the battery housing recess formed in the battery hatch and the face of the corresponding portion of the movement structure. In the latter battery hatch structure, on the other hand, the battery is clamped and fixed between the bottom face of the battery housing recess formed in the movement structure and the back face of the battery cover. When the electronic buzzer is to be assembled in the portable type watch having such battery hatch structure, the electronic buzzer has to be arranged at a portion apart from the battery cover. This raises a problem that the portable type watch is accordingly enlarged in size.

In JP-A-2003-98278 (i.e., Patent Publication 3), there is disclosed a portable type electronic device having a battery cover, in which a sound producing piezoelectric element is attached to the inner side of the battery cover. Specifically, there is disclosed an electronic device provided with: a wrist watch type portable type electronic device body having a battery cover having a battery housing recess for housing a button-type battery; and a battery cover mounted removably in the circular opening of the battery housing recess for clamping and holding the button-type battery, when mounted, in the battery housing recess. In this electronic device, a stepped recess is formed in the inner face of the battery cover body of the battery cover, and a sounding plate having the piezoelectric element for the sound production adhered thereto is fixed at its circumferential edge to the step portion of the stepped recess.

Moreover, the electronic device uses a lead terminal made of a spring metal material having an especial structure, so that one terminal face of the piezoelectric element adhered to the lower face of the sounding plate and the plus electrode face of the button-type battery may be electrically connected with each other. Specifically, the lead terminal is provided with a beam-shaped arm portion extending in the radial direction of the battery cover, and its leading end portion is provided with elastic supporting leg portions having a shape of paired leaf springs extending transversely at right angles with respect to the extending direction of the beam-shaped arm. One terminal face of the piezoelectric element and the lead terminal make a point contact at one portion, and the plus electrode face lead terminal of the button-type battery makes the point contact at two portions.

The electronic device, which is characterized in that the sound producing piezoelectric element is arranged in the battery cover, as disclosed in Patent Publication 3, can be provided with the sounding unit such as the electronic buzzer without enlarging the size of the electronic device body. However, the button-type battery is clamped through the lead terminal having the aforementioned especial structure between the sounding plate and the bottom face of the battery housing portion of the movement structure. This clamping structure raises a problem that the button-type battery is not firmly held in the battery housing recess. This is because the button-type battery is rocked on the three portions of the aforementioned point contacts in case an impact is applied to the electronic device body. The rocking motions of the button-type battery may be transmitted through the lead terminal made of the spring metal material to the sound producing piezoelectric element thereby to break the piezoelectric element.

The problem to be solved by the invention is to provide a portable type electronic device with a sounding function having a piezoelectric element, which fixes a button-type battery in a battery housing recess while making it possible for the user to replace the battery easily and which enables the piezoelectric element to produce a sound in a sufficient volume.

### SUMMARY OF THE INVENTION

In order to solve the above-specified problem, there is provided a portable type electronic device having a sounding function, comprising: an electronic device body including a battery cover mounted so that the user can replace a button-type battery housed in a battery housing recess; and a sounding unit including a piezoelectric element as a sounding element, characterized: in that a battery housing recess is formed in the inner side of said battery cover; and in that said piezoelectric element is so mounted on the bottom face of said battery cover recess that a clearance is formed between said piezoelectric element and the button-type battery housed in said battery housing recess.

### BRIEF DESCRIPTION OF THE SEVERAL VIEWS OF THE DRAWINGS

A preferred form of the present invention is illustrated in the accompanying drawings in which:

FIG. 1 is a sectional view of an essential portion of a portable type electronic watch with a sounding function of Embodiment 1;

FIG. 2 is a sectional view of an essential portion of a portable type electronic watch with a sounding function of a first modification of Embodiment 1;

FIG. 3 is a sectional view of an essential portion of a portable type electronic watch with a sounding function of a second modification of Embodiment 1;

FIG. 4 is a sectional view of an essential portion of a portable type electronic watch with a sounding function of a third modification of Embodiment 1;

FIG. 5 is a top plan view of a plate-shaped partition member to be used in the portable type electronic watch with a sounding function of the second modification of Embodiment 1;

FIG. 6 is a top plan view of a plate-shaped partition member to be used in the portable type electronic watch with a sounding function of the third modification of Embodiment 1;

FIG. 7A is a top plan view of an elastic plate member having a cross-shaped beam, and FIG. 7B is a sectional view of the portable type electronic watch with a sounding function of Embodiment 1 having the elastic plate member attached thereto;

FIG. 8A is a top plan view of an elastic plate member having a beam of parallel crosses, and FIG. 8B is a sectional view of the portable type electronic watch with a sounding function of Embodiment 1 having the elastic plate member attached thereto;

FIG. 9 is a top plan view of a circular elastic plate member having a honeycomb structure;

FIG. 10A is a top plan view of a donut-shaped elastic plate member, and FIG. 10B is a sectional view of the essential portion of the portable type electronic watch with a sounding function of Embodiment 1 having the elastic plate member attached thereto;

FIG. 11 is a sectional view of the portable type electronic watch with a sounding function of Embodiment 1 having the donut-shaped elastic plate member according to an embodiment attached thereto;

FIG. 12A is a top plan view of a circular, elastic plate member having battery fixing frames formed, and FIG. 12B is a sectional view of the essential portion of the portable type electronic watch with a sounding function of Embodiment 1 having the elastic plate member attached thereto;

FIG. 13A is a A top plan view of a circular, elastic plate member having a pair of cantilever beam portions, and FIG. 13B is a sectional view of the essential portion of the portable type electronic watch with a sounding function of Embodiment 1 having the elastic plate member attached thereto;

FIG. 14 is a sectional view of an essential portion of a portable type electronic watch with a sounding function of Embodiment 2;

FIG. 15A is a sectional view of the essential portion of a portable type electronic watch with a sounding function of Embodiment 3, and FIG. 15B is a sectional view thereof;

FIG. 16A is a sectional view of the essential portion of a portable type electronic watch with a sounding function of a first modification of Embodiment 3, and FIG. 16B is a sectional view thereof;

FIG. 17A is a sectional view of the essential portion of a portable type electronic watch with a sounding function of a second modification of Embodiment 3, and FIG. 17B is a sectional view thereof;

FIG. 18A is a sectional view of the essential portion of a portable type electronic watch with a sounding function of Embodiment 4, and FIG. 18B is a sectional view thereof; and

FIG. 19A is a sectional view of the essential portion of a portable type electronic watch with a sounding function of a modification of Embodiment 4, and FIG. 19B is a sectional view thereof.

### DETAILED DESCRIPTION OF THE PREFERRED EMBODIMENTS

According to the invention, there is also provided a portable type electronic device having a sounding function, comprising: an electronic device body including a battery cover mounted so that the user can replace a button-type battery housed in a battery housing recess; and a sounding unit including a piezoelectric element as a sounding element, characterized: in that said battery housing recess is formed in the electronic device body; in that said piezoelectric element is mounted on the bottom face of a battery cover recess formed in the inner side of said battery cover; and in that a plate-shaped partition member is arranged to have its circumferential edge portion fixed at its circumferential edge in the opening of said battery cover recess, such that a clearance is formed between said plate-shaped partition member and said piezoelectric element. With this construction, an acoustic space for the piezoelectric element to vibrate its film sufficiently is sufficiently retained, and the button-type battery housed in the battery housing recess is pushed by the plate-shaped partition member so that it is firmly fixed. When the battery cover is removed, moreover, the user can extract the button-type battery easily for the battery replacement from the battery housing recess.

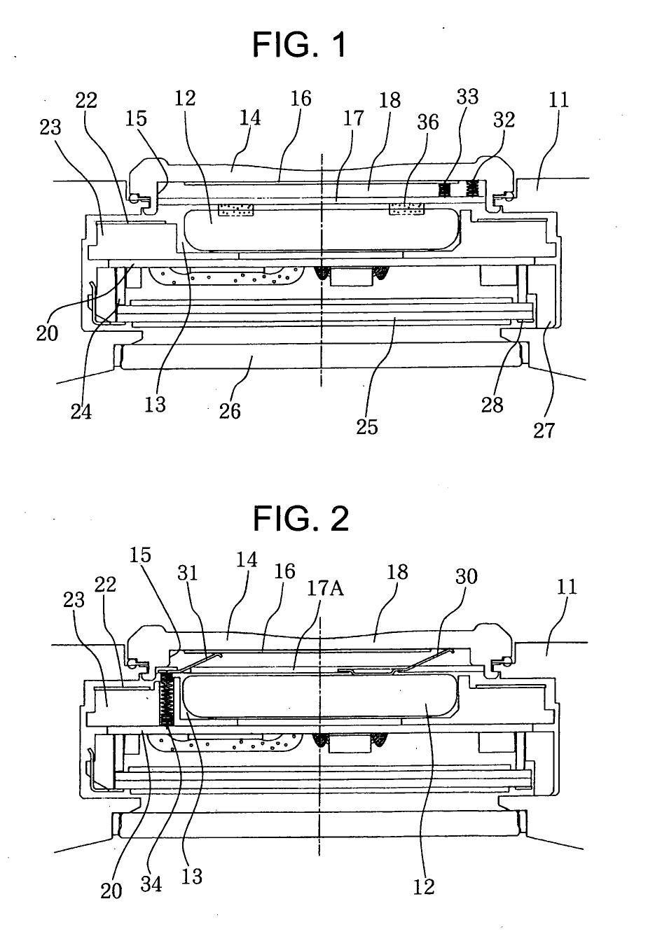

According to Embodiment 1 of the invention, as shown in FIG. 1 to FIG. 8, there is provided a portable type electronic watch having a sounding function, which is provided with: an electronic watch body 11 having a battery cover 14 mounted so that the user can replace a button-type battery 12 housed in a battery housing recess 13; and a sounding unit having a piezoelectric element 16 as a sounding element. This portable type electronic watch is characterized: in that the battery housing recess 13 is formed in the electronic watch body 11; in that the piezoelectric element 16 is mounted on the bottom face of a battery cover recess 15 formed on the inner side of the battery cover 14; and in that a plate-shaped partition member 17 is arranged in the opening of the battery cover recess 15 so as to have its circumferential edge portion fixed. Here, a clearance 18 to be formed between the plate-shaped partition member 17 and the piezoelectric element 16 functions as a sounding clearance.

The sounding portable type electronic watch, which is provided with the sounding unit using the piezoelectric element 16 as the sounding element, includes the electronic watch body 11, in which the battery cover 14 is removably mounted on the back side and in which a glass 26 is fixed on the surface side, as shown in a sectional view of an essential portion of FIG. 1. In the housing chamber formed between the battery cover 14 of the electronic watch body 11 and the glass 26, there are housed: an electronic watch module, which includes a printed circuit board 20 fixed in a module case 27 and a liquid crystal panel 25 attached to the module case 27 by a member 28 and connected with the printed circuit board 20 by a connector 20; and the button-type battery 12.

The battery housing recess 13 is formed in a battery guard 23 arranged over the printed circuit board 20. The internal diameter of the battery housing recess 13 regulates the internal diameter of the button-type battery 12. Moreover, the bottom face of the battery housing recess 13 regulates the position of the bottom of the button-type battery 12 and the position of the minus terminal of the power source (not-shown), against which the minus electrode of the button-type battery 12 abuts. A switch spring 22, which is arranged on the surface of the battery guard 23, is a conductive, elastic member, and elastically abuts against the plus electrode of the button-type battery 12 housed in the battery housing recess 13, thereby to regulate the transverse movement of the button-type battery 12 and to function as the plus terminal of the power source.

The battery cover recess 15 having a bottomed cylindrical shape is formed in the inner side of the battery cover 14. The piezoelectric element 16 or the sounding element of the electronic buzzer is adhered to the bottom face of the battery cover recess 15 by a conductive adhesive.

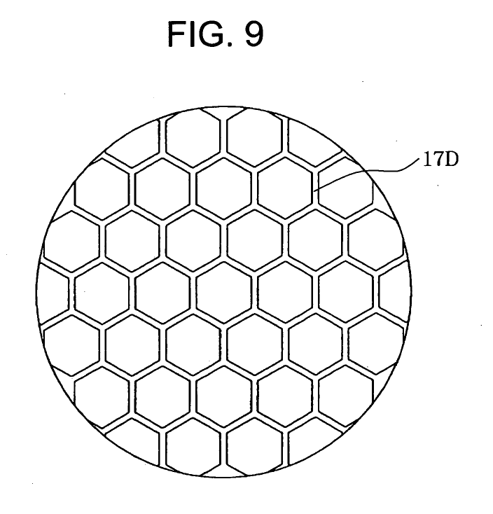

The plate-shaped partition member 17 or the circular, elastic plate member made of plastics is arranged in the opening of the battery cover recess 15 of the battery cover 14, and is fixed at its circumferential edge portion on the inner circumference of the battery cover recess 15 with an adhesive by forming the clearance 18 between itself and the piezoelectric element 16. A conducting printed circuit is formed on the surface of the plate-shaped partition member 17 of plastics. Moreover, the plate-shaped partition member 17 maybe a circular plate member 17D having an elastic honeycomb structure, which has its central portion deflected toward the battery, as shown in FIG. 9. The numerous hexagonal holes forming the circular plate member 17D of the honeycomb structure are sized to permit the conducting terminals to penetrate therethrough, and function as the through holes for the conducting terminals. The circular plate member 17D of the honeycomb structure may be an inelastic member of a flat plate having no deflection. Moreover, the numerous hexagonal holes may be formed not wholly but partially. In short, no especial limit is placed on the shape and material of the circular plate member 17D of the honeycomb structure.

In the sounding portable type electronic watch of FIG. 1 having the structure described above, the button-type battery 12 is housed in the battery housing recess 13 of the electronic watch body 11 to be firmly fixed. That is, the button-type battery 12 is regulated in its traverse movement by the switch spring 22 and the inner circumference of the battery-guard 23 while regulated in its vertical movement by being clamped by the bottom face of the battery guard 23 and the circular elastic plate member 17. A cushion member 36 lies between the circular elastic plate member 17 and the upper face of the button-type battery 12.

In the sounding portable type electronic watch of FIG. 1, one terminal of the piezoelectric element 16 is electrically connected from the bottom face of the battery cover recess 15 through a conducting terminal 32 with the conducting printed circuit, which is formed on the surface of the circular, elastic plate member 17. On the other hand, the other terminal of the piezoelectric element 16 is electrically connected through a conductive spring 33 with the aforementioned conducting printed circuit. This conducting printed circuit is electrically connected with the printed circuit board 20 by not-shown conducting means.

Thus, the piezoelectric element 16 oscillates, when fed with a sound signal from the printed circuit board 20 of the electronic watch module, in a circular diaphragm oscillation mode in the clearance 18 so that it produces the sound. The clearance 18 is formed by providing a predetermined space between the piezoelectric element 16 and the circular, elastic plate member 17 so that the sound produced is sufficient.

Next, a sounding portable type electronic watch, the essential portion of which is shown in FIG. 2, uses a circular, elastic plate member 17A made of plastics, which is assembled by arranging a first conducting contact leaf spring 30 as the plate-shaped partition member at the central portion and by arranging a second conducting contact leaf spring 31 at the circumferential edge portion.

The plate-shaped partition member 17A or the circular, elastic plate member made of plastics is arranged in the opening of the battery cover recess 15 of the battery cover 14 and is fixed at its circumferential edge portion on the step portion, which is formed on the inner circumference of the battery cover recess 15, with an adhesive while forming the clearance 18 between itself and the piezoelectric element 16.

In the sounding portable type electronic watch of FIG. 2, the button-type battery 12 is housed and firmly fixed in the battery housing recess 13 of the electronic watch body 11. Specifically, the button-type battery 12 is regulated in its transverse movement by the switch spring 22 and the inner circumference of the battery guard 23 and is so clamped between the bottom face of the battery guard 23 and the circular, elastic plate member 17A that it is regulated in the longitudinal direction.

In the sounding portable type electronic watch of FIG. 2, moreover, one terminal of the piezoelectric element 16 is electrically connected from the bottom face of the battery cover recess 15 through the conducting contact leaf spring 30 with the plus electrode of the button-type battery 12. The other terminal of the piezoelectric element 16 is electrically connected through the conducting contact leaf spring 31 with the printed circuit board 20. The conducting contact leaf springs 30 and 31 are assembled with plastics and molded into a member integrated with the plate-shaped partition member 17A.

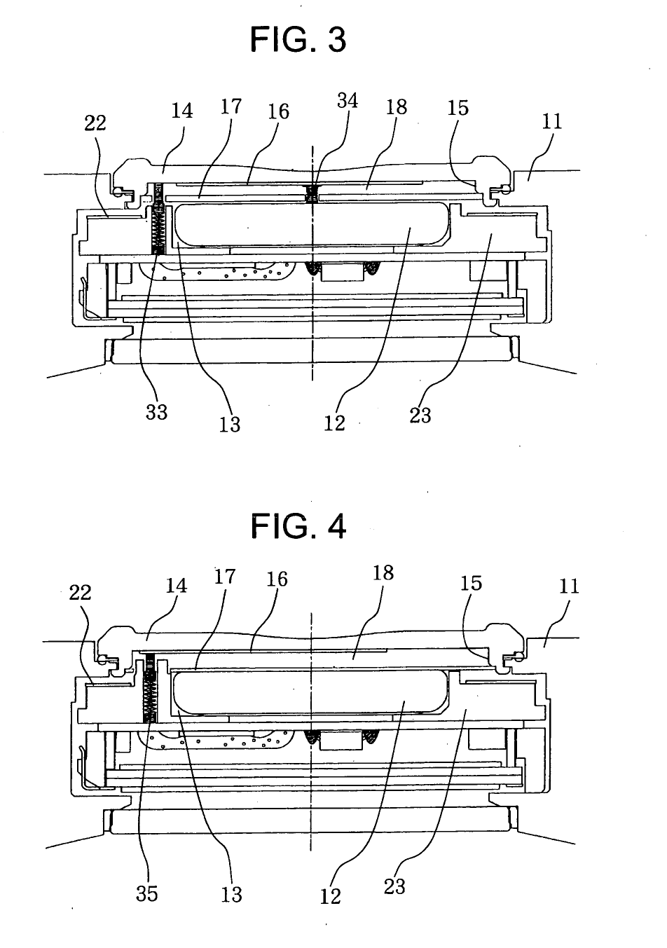

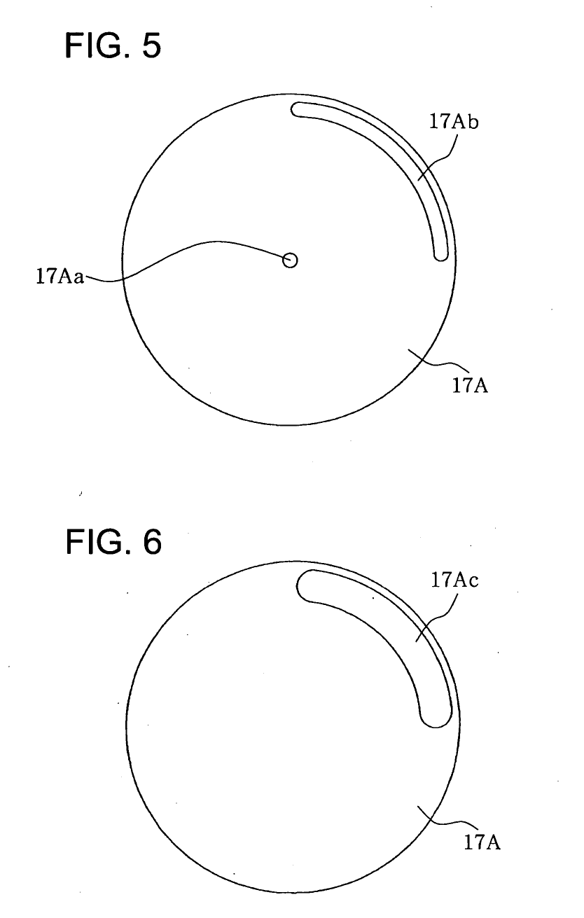

Next, a sounding portable type electronic watch, the essential portion of which is shown in FIG. 3, is configured by using the circular, elastic plate member 17A, as shown in FIG. 5, as the plate-shaped partition member. Specifically, the circular, elastic plate member 17A is provided at its central portion with a through hole 17Aa for the first conducting terminal and at its outer circumferential portion with an arcuate through holes 17Ab for the second conducting terminal.

The plate-shaped partition member 17A or the circular, elastic plate member made of a metal is arranged in the opening of the battery cover recess 15 of the battery cover 14, and is fixed at its circumferential edge portion on the inner circumference of the battery cover recess 15 by a spot welding method or the like to form the clearance 18 between itself and the piezoelectric element 16. Here, the plate-shaped partition member 17 may be either the elastic, circular plate member 17D of the honeycomb structure, which is deflected at its central portion toward the battery, as shown in FIG. 9, or a circular plate member of a honeycomb structure having another shape and of another material.

In the sounding portable type electronic watch of FIG. 3, the button-type battery 12 is housed and firmly fixed in the battery housing recess 13 of the electronic watch body 11. Specifically, the button-type battery 12 is regulated in the movement of the transverse direction by the switch spring 22 and the inner circumference of the battery guard 23 and is clamped between the bottom face of the battery guard 23 and the circular, elastic plate member 17A so that it is regulated in the movement of the longitudinal direction.

In the sounding portable type electronic watch of FIG. 3, moreover, one terminal of the piezoelectric element 16 is electrically connected from the bottom face of the battery cover recess 15 through the conductive spring 33 with the printed circuit board 20. The other terminal of the piezoelectric element 16 is electrically connected through a conductive spring 34 with the plus electrode of the button-type battery 12.

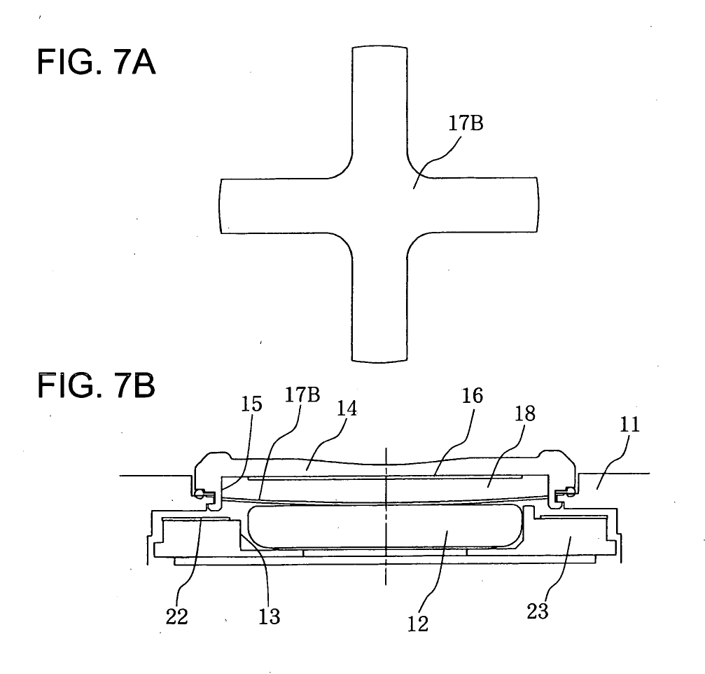

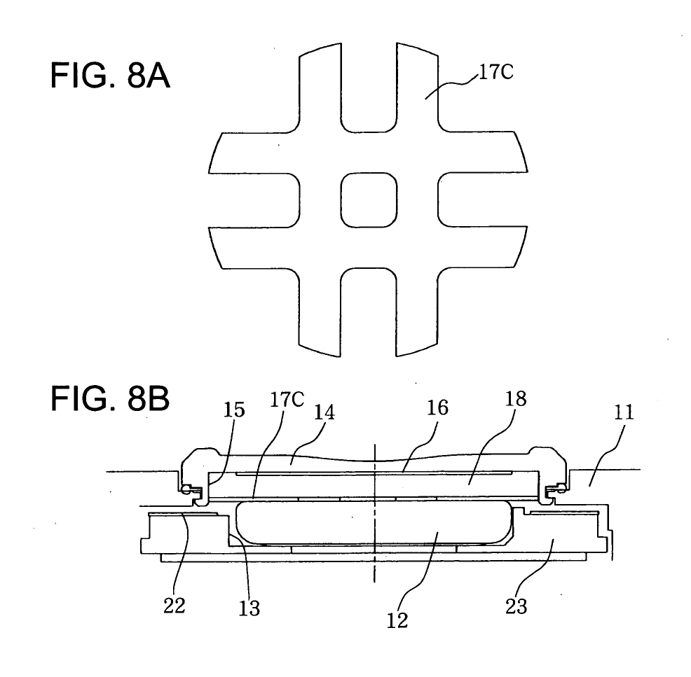

Here, the plate-shaped partition member 17 to be used in the sounding portable type electronic watch of FIG. 3 may be either an elastic plate member 17B having a cross-shaped beam deflected at its central portion toward the battery, as shown in FIG. 7A, or an elastic plate member 17C having a beam of parallel crosses deflected at its central portion toward the battery, as shown in FIG. 8A.

In the sounding portable type electronic watch, the essential portion of which is shown in FIG. 4, the plate-shaped partition member is the circular elastic plate member 17A, which has a wide, arcuate through hole 17Ac formed for the conducting terminal in its outer circumferential portion, as shown in FIG. 6. The wide, arcuate through hole 17Ac is sized to permit the projecting guide portion of a conductive spring 35 to penetrate therethrough, thereby to prevent the conductive spring 35 and the metallic plate member 17A from contacting with each other.

The plate-shaped partition member 17A made of a metal is arranged in the opening of the battery cover recess 15 of the battery cover 14, and is fixed at its circumferential edge portion on the inner circumference of the battery cover recess 15 by the spot welding method or the like to form the clearance 18 between itself and the piezoelectric element 16. Here, the plate-shaped partition member 17 may be either the elastic, circular plate member 17D of the honeycomb structure, which is deflected at its central portion toward the battery, as shown in FIG. 9, or a circular plate member of a honeycomb structure having another shape and of another material.

In the sounding portable type electronic watch of FIG. 4, the button-type battery 12 is housed and firmly fixed in the battery housing recess 13 of the electronic watch body 11. Specifically, the button-type battery 12 is regulated in the movement of the transverse direction by the switch spring 22 and the inner circumference of the battery guard 23 and is clamped between the bottom face of the battery guard 23 and the circular, elastic plate member 17A so that it is regulated in the movement of the longitudinal direction.

In the sounding portable type electronic watch of FIG. 4, moreover, one terminal of the piezoelectric element 16 is electrically connected through the conductive spring 35 with the printed circuit board 20. The other terminal of the piezoelectric element 16 is electrically connected through the battery cover 14 and the conductive, circular, elastic plate member 17A with the plus electrode of the button-type battery 12.

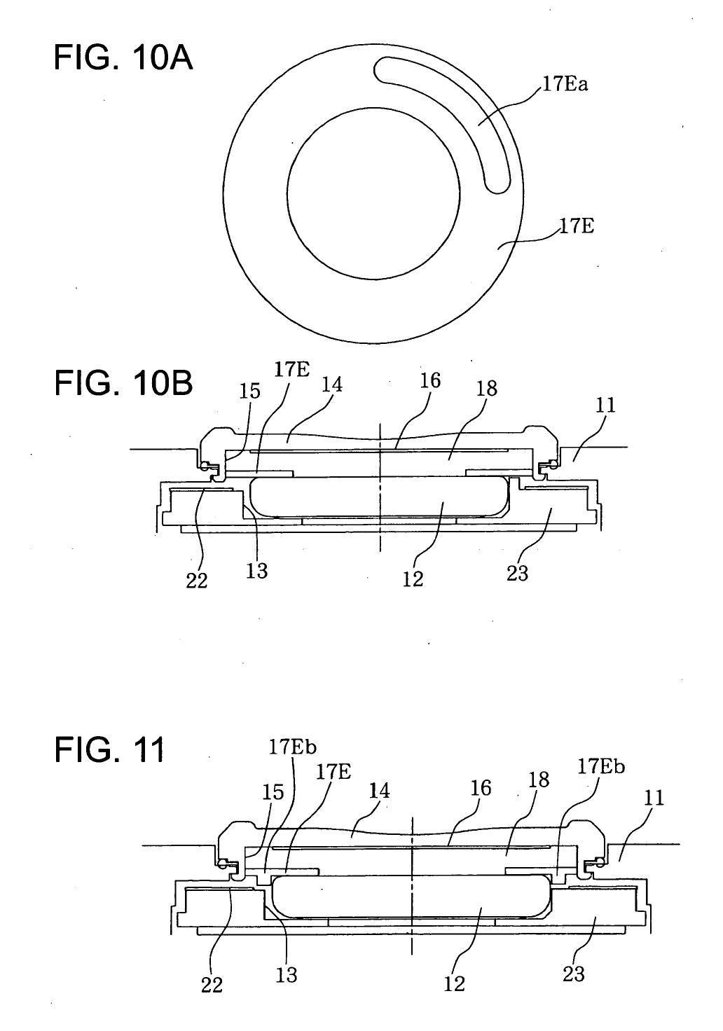

Next, a sounding portable type electronic watch, the essential portion of which is shown in FIG. 10B, exemplifies the plate-shaped partition member by either a donut-shaped conductive, elastic plate member 17E shown in FIG. 10A or the donut-shaped conductive, elastic plate member 17E which has a projection 17Eb formed for preventing the transverse displacement of the battery, as shown in FIG. 11. In the outer circumferential portion of the donut-shaped elastic plate member 17E, there is formed a wide, arcuate through hole 17Ea for the conducting terminal.

The donut-shaped conductive, elastic plate member 17E is made of a metal. The donut-shaped conductive, elastic plate member 17E is arranged in the opening of the battery cover recess 15 of the battery cover 14, and is fixed at its circumferential edge portion on the inner circumference of the battery cover recess 15 by the spot welding method or the like while forming the clearance 18 between itself and the piezoelectric element 16. Here, the plate-shaped partition member 17 may be either the elastic, circular plate member 17D of the honeycomb structure, which is deflected at its central portion toward the battery, as shown in FIG. 9, or a circular plate member of a honeycomb structure having another shape and of another material.

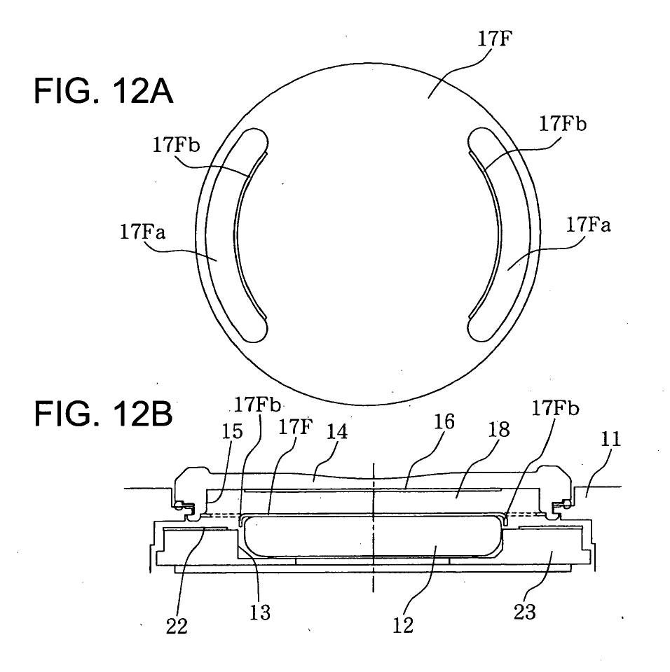

Next, the sounding portable type electronic watch, the essential portion of which is shown in section in FIG. 12B, exemplifies the plate-shaped partition member by a circular, elastic plate member 17F, in which a pair of wide, arcuate through holes for a pair of conducting terminals are symmetrically formed on the outer circumferential portion, as shown in FIG. 12A. Battery fixing frames 17Fb are formed on the circular, elastic plate member 17F on the side to abut against the battery. The battery fixing frames 17Fb are formed by folding the inner sides of wide, arcuate through holes 17Fa for the conducting terminals, as formed on the outer circumferential portions, toward the battery.

Here, the arcuate through holes need not be limited the to paired symmetrical shape but may be asymmetric or three or more.

In the sounding portable type electronic watch of FIG. 12B, the button-type battery 12 is housed and firmly fixed in the battery housing recess 13 of the electronic watch body 11. Specifically, the button-type battery 12 is regulated in the movement of the transverse direction by the switch spring 22 and the inner circumference of the battery guard 23 and is clamped between the bottom face of the battery guard 23 and the circular, elastic plate member 17F so that it is regulated in the movement of the longitudinal direction. The button-type battery 12 is further regulated in the movement of the transverse direction by the battery fixing frames 17Fb of the circular, elastic plate member 17F.

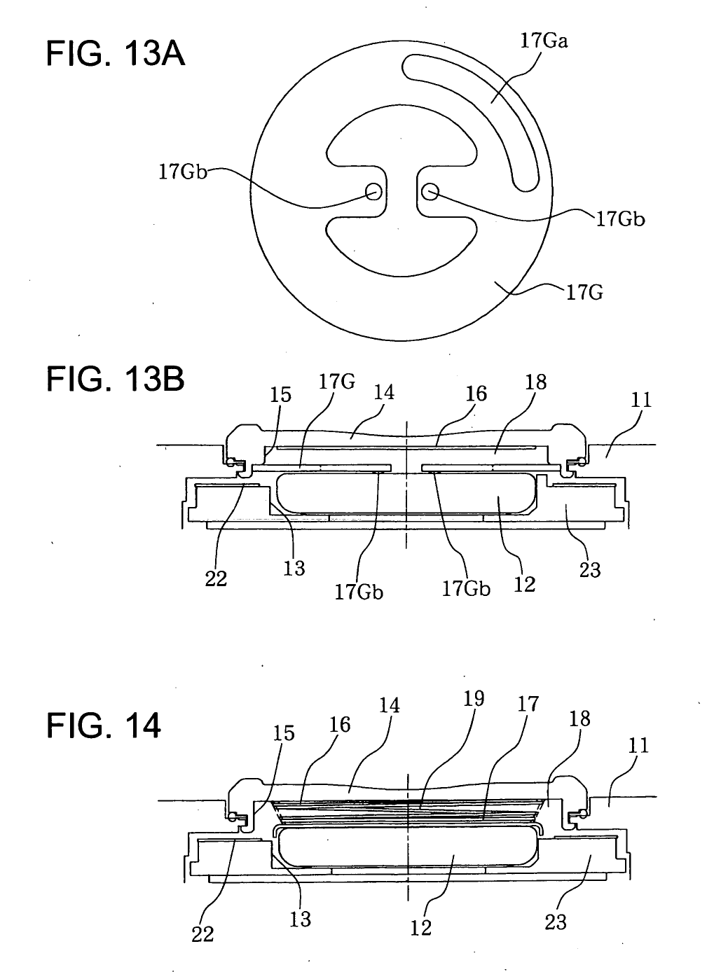

Next, the sounding portable type electronic watch, the essential portion of which is shown in section in FIG. 13B, exemplifies the plate-shaped partition member by a generally donut-shaped elastic plate member 17G which has cantilever beam portions, as shown in FIG. 13A. A pair of cantilever beam portions extending toward the central portion are formed in the generally donut-shaped elastic plate member 17G. In the outer circumferential portion of the circular elastic plate member 17G, moreover, there is formed a wide, arcuate through hole 17Ga for the conducting terminals. At the end portions of the cantilever beam portions, moreover, there are formed small projections 17Gb to abut against the plus electrode face of the button-type battery 12. Here, the cantilever beam portions may be one, or two or more.

In the sounding portable type electronic watch of FIG. 13B, the button-type battery 12 is housed and firmly fixed in the battery housing recess 13 of the electronic watch body. 11. Specifically, the button-type battery 12 is regulated in the movement of the transverse direction by the switch spring 22 and the inner circumference of the battery guard 23 and is clamped between the bottom face of the battery guard 23 and the circular, elastic plate member 17G so that it is regulated in the movement of the longitudinal direction.

Here in the portable type electronic watches having the sounding function of FIG. 10B, FIG. 12B and FIG. 13B;, the electric connections between one terminal of the piezoelectric element 16 and the printed circuit board 20, and the electric connections between the other terminal of the piezoelectric element 16 and the plus electrode of the button-type battery 12 can be made by using the aforementioned various connection means suitably.

According to Embodiment 2 of the invention, as shown in FIG. 14, there is provided a portable type electronic watch having a sounding function, which is provided with: an electronic watch body 11 having a battery cover 14 mounted so that the user can replace a button-type battery 12 housed in a battery housing recess 13; and a sounding unit having a piezoelectric element 16 as a sounding element. This portable type electronic watch is characterized: in that the battery housing recess 13 is formed in the electronic watch body 11; in that the piezoelectric element 16 is mounted on the bottom face of the battery cover recess 15 formed on the inner side of the battery cover 14; and in that a plate-shaped partition member 17 is so arranged in the opening of the battery cover recess 15 that it is pushed toward the battery by a coil spring 19 having a larger diameter than that of the piezoelectric element 16. The plate-shaped partition member 17 is provided on its outer circumference with battery fixing frames, which are formed by folding back the outer circumference toward the battery.

In the sounding portable type electronic watch of FIG. 14, the button-type battery 12 is housed and firmly fixed in the battery housing recess 13 of the electronic watch body 11. Specifically, the button-type battery 12 is regulated in the movement of the transverse direction by the switch spring 22 and the inner circumference of the battery guard 23 and is clamped between the bottom face of the battery guard 23 and the circular, elastic plate member 17F so that it is regulated in the movement of the longitudinal direction. The button-type battery 12 is further regulated in the movement of the transverse direction by the battery fixing frames of the circular, elastic plate member 17F.

Here in the portable type electronic watches having the sounding function of FIG. 14, the electric connections between one terminal of the piezoelectric element 16 and the printed circuit board 20, and the electric connections between the other terminal of the piezoelectric element 16 and the plus electrode of the button-type battery 12 can be made by using the aforementioned various connection means suitably.

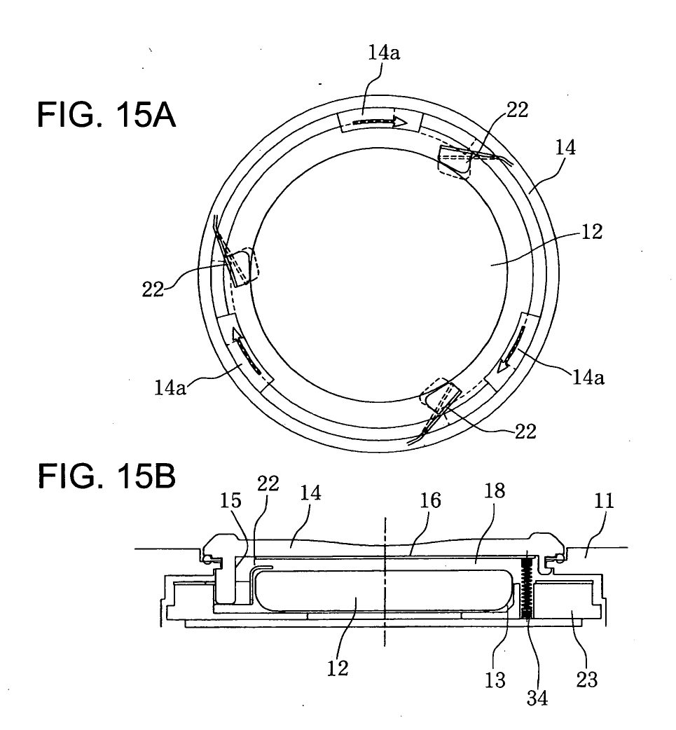

According to Embodiment 3 of the invention, as shown in FIG. 15 to FIG. 17, there is provided a portable type electronic watch having a sounding function, which is provided with: an electronic watch body 11 having a battery cover 14 mounted so that the user can replace a button-type battery 12 housed in a battery housing recess 13; and a sounding unit having a piezoelectric element 16 as a sounding element. This portable type electronic watch is characterized: in that the battery housing recess 13 is formed in the electronic watch body 11; in that the piezoelectric element 16 is mounted on the bottom face of the battery cover recess 15 formed on the inner side of the battery cover 14; and in that a battery fixing member for fixing the button-type battery 12 is arranged at the circumferential edge of the battery housing recess 13.

The battery fixing member is exemplified by a plurality of switch springs 22, as shown in FIG. 15, which are arranged at the circumferential edge portion of the battery housing recess 13 and pushed radially inward by the pawl portions 14a of the battery cover 14 when the battery cover 14 is turned and mounted.

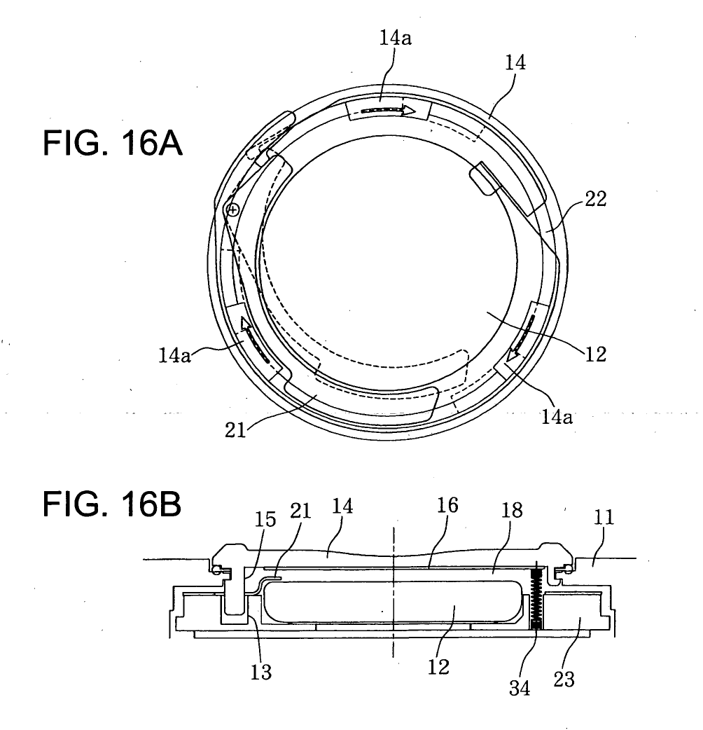

Alternatively, the battery fixing member is a fixing lever 21, as shown in FIG. 16, which is arranged at the circumferential edge portion of the battery housing recess 13 so as to be turnable on its axis and pushed radially inward by the pawl portions 14a of the battery cover 14 when the battery cover 14 is turned and mounted.

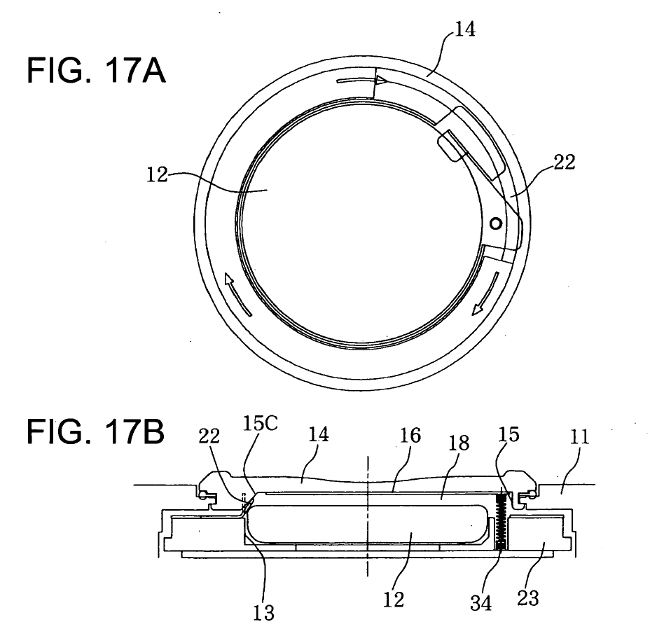

The battery fixing member is exemplified by the switch spring 22, as shown in FIG. 17, which is arranged at the circumferential edge portion of the battery housing recess 13 and pushed radially inward at its rising portion by the tapered inner circumference 15c of the battery cover recess 15 when the battery cover 14 is turned and mounted. The tapered inner circumference 15c of the battery cover recess 15 is sloped so that its internal diameter becomes gradually smaller from the opening end portion to the bottom face.

Here in the portable type electronic watches having the sounding function of FIG. 15 to FIG. 17, the electric connections between one terminal of the piezoelectric element 16 and the printed circuit board 20, and the electric connections between the other terminal of the piezoelectric element 16 and the plus electrode of the button-type battery 12 can be made by using the aforementioned various connection means suitably.

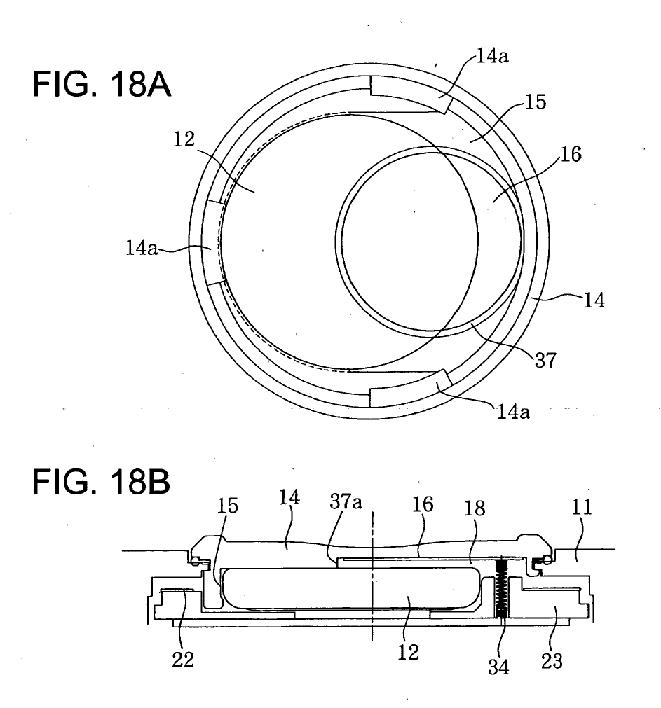

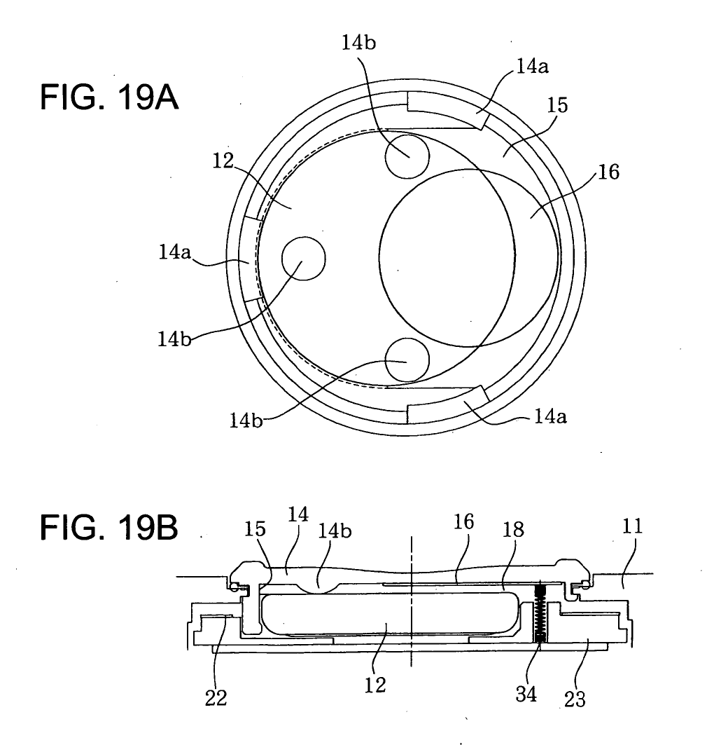

According to Embodiment 4 of the invention, as shown in FIG. 18 and FIG. 19, there is provided a portable type electronic watch having a sounding function, which is provided with: an electronic watch body 11 having a battery cover 14 mounted so that the user can replace a button-type battery 12 housed in a battery housing recess 13; and a sounding, unit having a piezoelectric element 16 as a sounding element. This portable type electronic watch is characterized: in that the battery housing recess 13 is formed to occupy most of the battery cover recess 15 formed in the inner side of the battery cover 14; and in that the piezoelectric element 16 is mounted on the bottom face of the battery cover recess 15 so as to avoid contact with the electrode face of the button-type battery 12 housed in the battery housing recess 13. Here, the clearance 18 to be formed between the button-type battery 12 and the piezoelectric element 16 functions as a sounding clearance.

One structure for mounting the piezoelectric element 16 on the bottom face of the battery cover recess 15 while forming the clearance between itself and the electrode face of the button-type battery housed in the battery housing recess 13 is the two-step bottom structure, as shown in FIG. 18, in which a portion of the bottom face of the battery cover recess 15 is further recessed to form a piezoelectric element housing recess 37 thereby to form a step portion 37a between the battery housing recess 13 and the piezoelectric element housing recess 37. In short, that step portion forms the clearance 18 between the plus electrode face of the button-type battery 12 housed in the battery housing recess 13 and the piezoelectric element 16 mounted in the piezoelectric element housing recess 37.

Another structure for mounting the piezoelectric element 16 on the bottom face of the battery cover recess 15 while forming the clearance between itself and the plus electrode face of the button-type battery 12 housed in the battery housing recess 13 is the bottom structure having projections, as shown in FIG. 19, in which a piezoelectric element mounting area is formed in a portion of the battery cover recess 15 and a plurality of projections 14b are formed at portions apart from the piezoelectric element mounting area. In short, those protrusions 14b form the clearance 18 between the plus electrode face of the button-type battery 12 housed in the battery housing recess 13 and the piezoelectric element 16 mounted in the bottom face of the battery cover recess 15. In other words, the projections 14b form the clearance between the button-type battery 12 and the piezoelectric element 16.

Here in the portable type electronic watches having the sounding function of FIG. 18 and FIG. 19, the electric connections between one terminal of the piezoelectric element 16 and the printed circuit board 20, and the electric connections between the other terminal of the piezoelectric element 16 and the plus electrode of the button-type battery 12 can be made by using the aforementioned various connection means suitably.

The electronic device having the sounding function according to the invention can be applied not only to a portable type multifunctional watch but also to various portable electronic devices having the function to give information to the user with the electronic sound.

According to the invention, there is provided a portable type electronic device having a sounding function, which is made practical with the battery cover having the sound producing piezoelectric element, that is, which has a small device body but a large sound volume although it has the button-type battery having a high battery capacity. In the portable type electronic device having the sounding function according to the invention, the button-type battery is firmly fixed in the battery housing recess and can be easily replaced by the user.

1. A portable type electronic device having a sounding function, comprising:
an electronic device body including a battery cover mounted so that the user can replace a button-type battery housed in a battery housing recess; and a sounding unit including a piezoelectric element as a sounding element,
wherein the battery housing recess is formed in the inner side of said battery cover; and the piezoelectric element is so mounted on the bottom face of said battery cover recess that a clearance is formed between said piezoelectric element and the button-type battery housed in said battery housing recess.

2. A portable type electronic device having a sounding function, comprising:
an electronic device body including a battery cover mounted so that the user can replace a button-type battery housed in a battery housing recess; and a sounding unit including a piezoelectric element as a sounding element,
wherein said battery housing recess is formed in the electronic device body; said piezoelectric element is mounted on the bottom face of a battery cover recess formed in the inner side of said battery cover; and a plate-shaped partition member is arranged to have its circumferential edge portion fixed at its circumferential edge in the opening of said battery cover recess, such that a clearance is formed between said plate-shaped partition member and said piezoelectric element.

3. A portable type electronic device having a sounding function of claim 2, wherein said plate-shaped partition member is a circular plate member made of plastics and having a conducting printed circuit formed on its surface.

4. A portable type electronic device having a sounding function of claim 2, wherein said plate-shaped partition member is a circular plate member made of plastics and having a pair of conducting contact leaf springs assembled as an integral member in the plastics.

5. A portable type electronic device having a sounding function of claim 2, wherein said plate-shaped partition member is a plate member having a through hole for a conducting terminal.

6. A portable type electronic device having a sounding function of claim 5, wherein said plate member having the through hole for the conducting terminal is a circular plate member having a through hole formed in its central portion for a first conducting terminal and an arcuate through hole formed in its outer circumferential portion for a second conducting terminal.

7. A portable type electronic device having a sounding function of claim 5, wherein the plate member having said through hole formed for the conducting terminal is a circular plate member having a wider, arcuate through hole formed in the outer circumference for the conducting terminal.

8. A portable type electronic device having a sounding function of claim 5, wherein the plate member having said through hole formed for the conducting terminal is a donut-shaped plate member having a wider, arcuate through hole formed in the outer circumference for the conducting terminal.

9. A portable type electronic device having a sounding function of claim 5, wherein the plate member having said through hole formed for the conducting terminal is a donut-shaped plate member having a wider, arcuate through hole formed in the outer circumference for the conducting terminal and a battery fixing projection formed on the side to abut against the battery.

10. A portable type electronic device having a sounding function of claim 5, wherein the plate member having said through hole formed for the conducting terminal is a donut-shaped plate member having a pair of wider, arcuate through holes formed symmetrically in the outer circumference for the conducting terminal and battery fixing frames formed on the side to abut against the battery.

11. A portable type electronic device having a sounding function of claim 5, wherein the plate member having said through hole formed for the conducting terminal is a substantially donut-shaped plate member having a wider, arcuate through hole formed in the outer circumference for the conducting terminal and cantilever beam portions formed to extend toward the central portion.

12. A portable type electronic device having a sounding function of claim 5, wherein the plate member having said through hole formed for the conducting terminal is an elastic plate member having a cross-shaped beam.

13. A portable type electronic device having a sounding function of claim 5, wherein the plate member having said through hole formed for the conducting terminal is an elastic plate member having a ridge of parallel crosses deflected at its central portion toward the battery.

14. A portable type electronic device having a sounding function of claim 5, wherein the plate member having said through hole formed for the conducting terminal is a circular plate member having a honeycomb structure.

15. A portable type electronic device having a sounding function, comprising:
an electronic device body including a battery cover mounted so that the user can replace a button-type battery housed in a battery housing recess; and a sounding unit including a piezoelectric element as a sounding element,
wherein said battery housing recess is formed in the electronic device body; said piezoelectric element is mounted on the bottom face of a battery cover recess formed in the inner side of said battery cover; and a plate-shaped partition member is so arranged in the opening of said battery cover recess that a clearance is formed between itself and said piezoelectric element and that it is pushed toward the battery by a coil spring having a larger diameter than that of said piezoelectric element.

16. A portable type electronic device having a sounding function, comprising:
an electronic device body including a battery cover mounted so that the user can replace a button-type battery housed in a battery housing recess; and a sounding unit including a piezoelectric element as a sounding element,
wherein said battery housing recess is formed in the electronic device body; said piezoelectric element is mounted on the bottom face of a battery cover recess formed in the inner side of said battery cover; and a battery fixing member arranged at the circumferential edge portion of said battery housing recess fixes said button-type battery while leaving a clearance between itself and said piezoelectric element.

17. A portable type electronic device having a sounding function of claim 16, wherein said battery fixing member includes a plurality of switch springs arranged at the circumferential edge portion of said battery housing recess and pushed radially inward by the pawl portions of the battery cover when the battery cover is turned and mounted.

18. A portable type electronic device having a sounding function of claim 16, wherein said battery fixing member includes a fixing lever arranged at the circumferential edge portion of said battery housing recess to be turnable on its axis and pushed radially inward by the pawl portions of the battery cover when said battery cover is turned and mounted.

19. A portable type electronic device having a sounding function of claim 16, wherein said battery fixing member includes a plurality of switch springs arranged at the circumferential edge portion of said battery housing recess and pushed radially inward at their rising portions by the tapered inner circumference of said battery cover recess when said battery cover is turned and mounted.

20. A portable type electronic device having a sounding function, comprising:
an electronic device body including a battery cover mounted so that the user can replace a button-type battery housed in a battery housing recess and a sounding unit including a piezoelectric element as a sounding element;
wherein said battery housing recess is formed in a portion of a battery cover recess formed in the inner side of said battery cover; and said piezoelectric element is mounted on the bottom face of said battery cover recess so as to form a clearance between itself and said button-type battery.

21. A portable type electronic device having a sounding function of claim 20, wherein said piezoelectric element is mounted on the bottom face of the piezoelectric element housing recess formed by further recessing the bottom face of said battery cover recess partially.

22. A portable type electronic device having a sounding function of claim 20, wherein said battery cover recess has projections formed on its bottom face for forming a clearance between said piezoelectric element and said button-type battery.
